(19) United States
(12) Patent Application Publication
(10) Pub. No.: US 2026/0163874 A1
(43) Pub. Date: Jun. 11, 2026

(54) SYSTEMS AND METHODS FOR VERIFYING USER ACTIVITY WITH A USER

(71) Applicant: FoxIO, LLC, Austin, TX (US)

(72) Inventors: John B. Althouse, Round Hill, VA (US); Gary Lipsky, Austin, TX (US); Brian J. Philpott, Austin, TX (US)

(21) Appl. No.: 19/182,212

(22) Filed: Apr. 17, 2025

Related U.S. Application Data
(60) Provisional application No. 63/635,574, filed on Apr. 17, 2024.

(51) Int. Cl. H04L 9/40

(52) U.S. Cl. CPC H04L 63/08; H04L 2463/082

(57) ABSTRACT

Systems and methods are disclosed for verifying user activity within an enterprise communication environment. A user verification application (UVA) facilitates secure validation of user identity during interactions by integrating with enterprise communication applications (e.g., chat applications) and authentication systems. Upon receiving a verification request, the UVA sends a prompt to the target user, allowing them to affirm or deny engagement in a specific communication. If affirmed, the user is required to authenticate using a linked authentication application. The outcome of the verification process is communicated to both parties. The system supports customizable messages, multi-factor authentication, timeout handling, and can be triggered manually, by predefined criteria, or automatically using machine learning or SOC-level controls. This approach mitigates phishing risks and enhances security in enterprise user interactions.

### CROSS REFERENCE TO RELATED APPLICATION

This application claims the benefit of U.S. Prov. App. Ser. No. 63/635,574, titled SYSTEMS AND METHODS FOR VERIFYING USER ACTIVITY WITH A USER, filed on Apr. 17, 2024. The application cited in this paragraph is hereby incorporated by reference as if set forth fully herein.

### BACKGROUND OF THE INVENTION

### Field of the Invention

The disclosure relates to enterprise security and, more particularly, systems and methods for verifying user activity on a system with that user.

### Description of the Related Art

In enterprise systems, when an employee receives a phishing call or text message from someone pretending to work at that organization, that employee is usually unsure if the other person is who they say they are. However, with no way to validate that the employee is indeed talking to who they think they are, the employee usually follows through with the attacker's goals.

When a usual security alert is triggered by a particular employee, the most common action the Security Operations Center (SOC) analysts take is to contact that user and validate if they took the action that triggered the alert. Then a SOC analyst may follow up to ask why the action was taken. This back-and-forth interaction is extremely tedious and is usually done over a company chat application (like Slack); however, if the Slack account is compromised, then there is no way to validate the user.

Thus, there is a need for a way to efficiently and reliably verify user actions with on a system.

### SUMMARY OF THE DISCLOSURE

According to one embodiment of the present disclosure, a method for verifying user activity within a communication system comprises the following steps. A user verification application (UVA) is initiated via a communication application, the UVA receiving a verification request from a requester. A message is sent to a destination user by the UVA, wherein the message prompts the destination user to confirm the validity of the communication. A response is received by the UVA from the destination user indicating whether the user is currently engaged in the communication with the requester. Upon receiving a positive confirmation, the destination user is prompted to complete an authentication process via an authentication application. The destination user's identity is verified based on the completion of the authentication process. Both the requester and the destination user are notified of the successful verification of the user activity.

According to another embodiment of the present disclosure, a system for verifying user activity in an enterprise communication environment comprises the following components. A communication interface is configured to interact with a communication application to send and receive messages. An authentication interface is configured to communicate with one or more authentication applications. A user verification application (UVA) is in communication with the communication interface and the authentication interface and comprises the following components. A verification request module is configured to receive a verification request from a requester. A notification module is configured to send a verification prompt to a destination user via the communication application. A response handling module is configured to receive a response from the destination user indicating whether the destination user is currently communicating with the requester. An authentication module is configured to initiate an authentication process with the authentication application if the response indicates affirmation. A result notification module is configured to notify the requester and the destination user of the outcome of the verification.

### BRIEF DESCRIPTION OF THE DRAWINGS

FIG. 1 is a flowchart illustrating a method/system for verifying user activity within a communication system according to embodiments of the present disclosure.

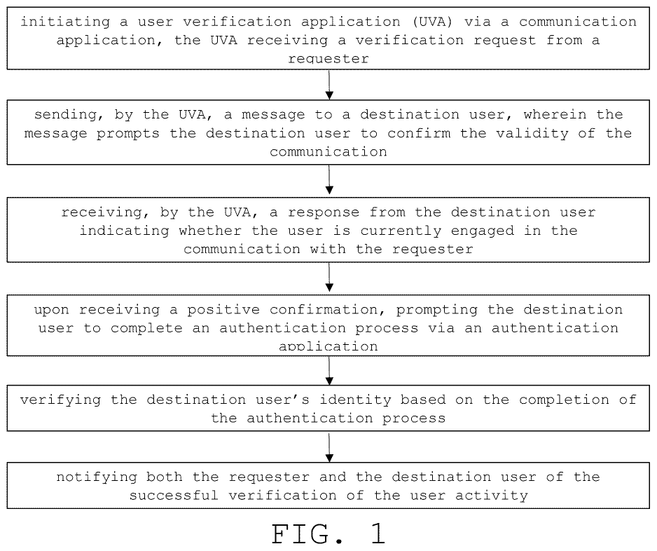

### DETAILED DESCRIPTION OF THE DISCLOSURE

Certain embodiments of the disclosure are described below.

Throughout this description, preferred embodiments and examples illustrated should be considered as exemplars, rather than as limitations on the present disclosure. As used herein, the term “device,” “method,” “disclosure,” “present device,” “present method,” or “present disclosure” refers to any one of the embodiments of the disclosure described herein, and any equivalents. Furthermore, reference to various feature(s) of the “device,” “method,” “disclosure,” “present device,” “present method,” or “present disclosure” throughout this document does not mean that all claimed embodiments or methods must include the referenced feature(s).

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc., may be used herein to describe various elements, components, or steps, these elements, components, or steps should not be limited by these terms. These terms are only used to distinguish one element, component, or step from another element, component, or step. Thus, a first element or component discussed below could be termed a second element or component without departing from the teachings of the present disclosure. As used herein, the term “and/or” includes any and all combinations of one or more of the associated list items.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” “including,” “has,” “having,” and similar terms, when used herein, specify the presence of stated features, integers, steps, operations, elements, and/or components, but do not preclude the presence or addition of one or more other features, integers, steps, operations, elements, components, and/or groups thereof.

### User Verification Application

Enterprises frequently use chat applications to facilitate intercompany communication. One such application is Slack. Throughout the disclosure, reference is made to systems and methods that interact with Slack. It is understood that Slack is used as an exemplary chat application for purposes of discussion. The systems and methods disclosed herein may be used with other enterprise chat/communication applications and other kinds of applications as well. A chat application, like Slack for example, is aware of all employees in the company, their Slack accounts and their and their authentication application (e.g., OAuth) accounts. One exemplary usage of an application according to this disclosure is designed to, when prompted, initiate an “employee verification” method starting with a direct message (DM) from the app and confirming with multi-factor authentication (MFA). This exemplary use case will be referred to herein as a user verification application (UVA).

The UVA can be configured with default messages for the requester and the respondent as well as available authentication tools and information related to communication protocols with those tools. The UVA can be configured to provide multiple options for a respondent to choose as well as the level of authentication required to validate and the timeout for a given kind of request.

Once a requester initiates the UVA to verify a user, the requester can customize the message that it is sending to the destination user. The UVA will then notify the destination user with priority app notifications, providing the requester's message and option buttons to select. If the destination user does not respond within the timeout window, the option buttons are removed or deactivated and both users are told the request timed out because the destination user did not respond. If the destination user clicks a “yes” option to validate itself, the user is then sent to its authentication application. Successful completion of authentication will automatically notify both users that validation was successful with optional messaging as configured in the UVA.

### Usage Example

Alice receives a phone call from Bob. Bob is a co-worker asking for Alice to do something for him. Alice has been trained to validate all employee interactions that are not normal, and this particular request is not normal. Using Slack, Alice DMs the UVA and with the following message:
“/uva-verify @bob”.
   The UVA responds to Alice with the following:
“OK, I will verify Bob. Please wait . . . ”.
   This causes the UVA to DM Bob as follows:
“Alice wants to confirm that you two are currently talking. Are you currently talking with Alice? [yes (verification required)] [no]”

If Bob selects “yes” the UVA takes him through his normal company authentication application (e.g., OAuth) login process. Once the login is complete the app will respond to both Alice and Bob saying, “Bob has successfully verified that he is currently talking to you.”

If, instead, Bob selects “no”, then the UVA responds to Bob with “OK, I will let Alice know.” The UVA responds to Alice stating, “Bob has denied that they are talking to you. Stop communications and contact your security team right away.”

If Bob does not respond after 30 seconds (a likely scenario in the case of a phishing call), the UVA responds to Bob stating: “The link has timed out”, and the links are no longer usable. The UVA will respond to Alice saying “Bob failed to respond. Stop communications immediately as this is likely a phishing attempt.”

In order for this to work with a communication application, e.g., Slack, there would need to be an intermediary running between the communication application the associated authentication application (e.g., Okta, Duo, or the like) to handle requests and responses between the communication application and the authentication application.

### Automated Initiation

Given the previous exemplary use case, it is possible to allow a user to automate initiation of the UVA according to certain criteria. For example, with reference to the scenario involving Alice and Bob outlined above, Alice may want to automate initiation of the UVA in the future given a certain trigger. For example, if any user on the system sends a request similar to the one sent by Bob that Alice considered to be abnormal, the UVA can identify the request and initiate verification without further input from Alice. In another example, Alice may want verification for all communications from Bob (or Bob's group). Automation can be based on any kind of criteria and can be based on a single trigger criterion or a combination of criteria.

Automation can be selected manually by a user that has permission to do so, or it can be selected at the SOC level. Automation can also be selected automatically, for example, if a certain number of users initiate verification when presented with at certain kind of request, then the UVA can be initiated automatically in the future for similar requests. Thus, automation can be selected without manual input from a user. Artificial intelligence, machine learning, or the like may be leveraged to determine instances when automated initiation of the UVA would be beneficial.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present disclosure has been described in detail with reference to certain preferred configurations thereof, other versions are possible. Embodiments of the present disclosure can comprise any combination of compatible features shown in the various figures, and these embodiments should not be limited to those expressly illustrated and discussed. Therefore, the spirit and scope of the disclosure should not be limited to the versions described above. Moreover, it is contemplated that combinations of features, elements, and steps from the appended claims may be combined with one another as if the claims had been written in multiple dependent form and depended from all prior claims. Combination of the various devices, components, and steps described above and in the appended claims are within the scope of this disclosure. The foregoing is intended to cover all modifications and alternative constructions falling within the spirit and scope of the disclosure.

We claim:

1. A method for verifying user activity within a communication system, comprising:
initiating a user verification application (UVA) via a communication application, the UVA receiving a verification request from a requester;
sending, by the UVA, a message to a destination user, wherein the message prompts the destination user to confirm the validity of the communication;
receiving, by the UVA, a response from the destination user indicating whether the user is currently engaged in the communication with the requester;
upon receiving a positive confirmation, prompting the destination user to complete an authentication process via an authentication application;
verifying the destination user's identity based on the completion of the authentication process; and
notifying both the requester and the destination user of the successful verification of the user activity.

2. The method of claim 1, wherein the verification request is triggered automatically based on predefined criteria selected from the group consisting of: abnormal communication requests, specific user communication, and requests flagged by a security operations center.

3. The method of claim 1, wherein the UVA sends a timeout notification to both the requester and the destination user if no response is received from the destination user within a specified time period.

4. The method of claim 1, further comprising providing an option for the destination user to deny the communication, wherein, if the destination user denies, the UVA notifies the requester to stop the communication.

5. The method of claim 1, wherein the UVA is configured to send priority notifications to the destination user to ensure timely responses to the verification request.

6. The method of claim 1, wherein the UVA includes customizable message templates for the requester to personalize the verification request sent to the destination user.

7. The method of claim 1, wherein the authentication process involves multi-factor authentication (MFA) performed via an external authentication application.

8. The method of claim 1, wherein the UVA interfaces with a third-party authentication system to facilitate the identity verification process.

9. The method of claim 1, wherein the UVA can be configured to run on multiple communication platforms and adapt its functionality based on the communication platform in use.

10. The method of claim 1, further comprising allowing a user to automate the initiation of the UVA based on patterns of communication and security flags determined by machine learning.

11. The method of claim 1, wherein the UVA responds to the requester with a message confirming whether the user has successfully verified or denied their involvement in the communication.

12. A system for verifying user activity in an enterprise communication environment, comprising:
a communication interface configured to interact with a communication application to send and receive messages;
an authentication interface configured to communicate with one or more authentication applications; and
a user verification application (UVA) in communication with the communication interface and the authentication interface, the UVA comprising:
a verification request module configured to receive a verification request from a requester;
a notification module configured to send a verification prompt to a destination user via the communication application;
a response handling module configured to receive a response from the destination user indicating whether the destination user is currently communicating with the requester;
an authentication module configured to initiate an authentication process with the authentication application if the response indicates affirmation; and
a result notification module configured to notify the requester and the destination user of the outcome of the verification.

13. The system of claim 12, wherein the communication application comprises a chat platform.

14. The system of claim 12, wherein the UVA further comprises a timeout module configured to detect a lack of response from the destination user within a predefined time window and deactivate response options.

15. The system of claim 12, wherein the UVA is configured to present the destination user with selectable response options including a verification-required affirmative option and a negative denial option.

16. The system of claim 12, wherein the UVA further comprises a configuration module allowing customization of: requester messages, response options, authentication requirements, and timeout durations.

17. The system of claim 12, wherein the UVA is configured to initiate a verification process automatically based on predefined trigger criteria.

18. The system of claim 17, wherein the trigger criteria include behavioral patterns, predefined user communication rules, and security flags initiated by a security operations center.

19. The system of claim 12, further comprising a machine learning engine configured to analyze communication patterns and recommend or automatically initiate verification processes based on risk factors.

20. The system of claim 12, wherein the UVA further comprises an intermediary service configured to facilitate data exchange between the communication application and the authentication application.
